(19) United States
(12) Patent Application Publication
(10) Pub. No.: US 2020/0358637 A1
(43) Pub. Date: Nov. 12, 2020

(54) INFORMATION PROCESSING SYSTEM, AND PLATFORM

(71) Applicant: FUJITSU CLIENT COMPUTING LIMITED, Kanagawa (JP)

(72) Inventors: Yuji Nakayama, Kanagawa (JP); Masatoshi Kimura, Kanagawa (JP)

(73) Assignee: FUJITSU CLIENT COMPUTING LIMITED, Kanagawa (JP)

(21) Appl. No.: 16/834,392

(22) Filed: Mar. 30, 2020

(30) Foreign Application Priority Data
May 8, 2019 (JP) 2019-088561

(51) Int. Cl. H04L 12/46; H04L 12/40; H04L 29/08; H04L 29/06

(52) U.S. Cl. CPC H04L 12/4641; H04L 12/462; H04L 67/42; H04L 67/1097; H04L 12/40013

(57) ABSTRACT

An information processing system includes a relay device having an expansion bus and a plurality of platforms connected to each other via the expansion bus. An access source platform includes a first bridge driver that communicates with an access destination platform via the expansion bus, a first virtual LAN driver that recognizes the access destination platform as a platform on a virtual LAN, generates a first access request for a storage in the access destination platform, and transmits the first access request to the access destination platform via the first bridge driver, and a first block device driver that recognizes the storage as a storage connected to the access source platform, generates a second access request for the storage, and transmits the second access request to the access destination platform via the first bridge driver.

### CROSS-REFERENCE TO RELATED APPLICATIONS

This application is based upon and claims the benefit of priority from Japanese Patent Application No. 2019-088561, filed May 8, 2019, the entire contents of which are incorporated herein by reference.

### BACKGROUND

### Technical Field

Embodiments described herein relate generally to an information processing system, and a platform.

### Description of the Related Art

There is an information processing system including a relay device having an expansion bus such as PCIe and a plurality of platforms connected to each other via the expansion bus.

However, for the information processing system, a technology, in which a storage provided in any one of the platforms (hereinafter, referred to as an access destination platform) is shared by another platform (hereinafter, referred to as an access source platform), has been developed.

In such a case, the access source platform recognizes the access destination platform as a platform on a virtual LAN, generates an access request for a storage provided in the access destination platform, and transmits the generated access request to the access destination platform via the relay device. Furthermore, the access destination platform recognizes the access source platform as a platform on the virtual LAN, receives the access request from the access source platform via the relay device, and accesses the storage according to the access request.

However, when the access source platform and the access destination platform recognize each other as the platforms on the virtual LAN and transmit/receive the access request, there is a need for processing and the like of converting the access request into an access request according to a communication standard of the virtual LAN, resulting in an increase in overhead in accessing the storage provided in the access destination platform.

An information processing system according to a first aspect of the present invention includes a relay device having an expansion bus and a plurality of platforms connected to each other via the expansion bus. An access source platform includes a first bridge driver that is communicable with an access destination platform via the expansion bus, a first virtual LAN driver that recognizes the access destination platform as the platform on a virtual LAN, generates a first access request for a storage provided in the access destination platform, and transmits the first access request to the access destination platform via the first bridge driver, and a first block device driver that recognizes the storage as a storage connected to the access source platform, generates a second access request for the storage, and transmits the first access request to the access destination platform via the first bridge driver. The access destination platform includes a second bridge driver that is communicable with the access source platform via the expansion bus and determines whether an access request for the storage, the access request being received from the access source platform, is the first access request or the second access request, a second virtual LAN driver that recognizes the access source platform as the platform on the virtual LAN and receives the first access request from the access source platform via the second bridge driver, and a second block device driver that recognizes the storage as the storage connected to the access source platform, receives the second access request via the second bridge driver, and accesses the storage based on the second access request.

### SUMMARY

According to a first aspect of this disclosure, in general, an information processing system includes a relay device that has an expansion bus and a plurality of platforms that are connected to each other via the expansion bus. The platform serving as an access source platform includes a first bridge driver that communicates with the platform serving an access destination platform via the expansion bus, a first virtual LAN driver that recognizes the access destination platform as the platform on a virtual LAN, generates a first access request for a storage that is provided in the access destination platform, and transmits the first access request to the access destination platform via the first bridge driver, and a first block device driver that recognizes the storage as a storage connected to the access source platform, generates a second access request for the storage, and transmits the second access request to the access destination platform via the first bridge driver. The access destination platform includes a second bridge driver that communicates with the access source platform via the expansion bus and determines whether an access request for the storage, the access request being received from the access source platform, is the first access request or the second access request, a second virtual LAN driver that recognizes the access source platform as the platform on the virtual LAN and receives the access request determined as the first access request by the second bridge driver, and a second block device driver that recognizes the storage as the storage connected to the access source platform, receives the access request determined as the second access request by the second bridge driver, and accesses the storage based on the second access request.

According to a second aspect of this disclosure, in general, a platform includes a bridge driver that communicates with an access destination platform via an expansion bus provided in a relay device, a virtual LAN driver that recognizes the access destination platform as a platform on a virtual LAN, generates a first access request for a storage that is provided in the access destination platform, and transmits the first access request to the access destination platform via the bridge driver, and a block device driver that recognizes the storage as a storage connected to the block device driver, generates a second access request for the storage, and transmits the second access request to the access destination platform via the bridge driver.

According to a third aspect of this disclosure, in general, a platform includes a storage, a bridge driver that communicates with an access source platform via an expansion bus provided in a relay device and determines whether an access request for the storage, the access request being received from the access source platform, is a first access request transmitted after the access source platform is recognized as a platform on a virtual LAN or a second access request transmitted after the storage is recognized as a storage connected to the access source platform, a virtual LAN driver that recognizes the access source platform as the platform on the virtual LAN and receives the access request determined as the first access request by the bridge driver, and a block device driver that recognizes the storage as the storage connected to the access source platform, receives the access request determined as the second access request by the bridge driver, and accesses the storage based on the second access request.

### BRIEF DESCRIPTION OF THE DRAWINGS

FIG. 1 is a diagram illustrating an example of an overall configuration of an information processing system according to an embodiment;

FIG. 2 is a diagram illustrating an example of a hardware configuration of the information processing system according to the present embodiment;

FIG. 3 is a diagram illustrating an example of a software configuration of a platform of the information processing system according to the present embodiment;

FIG. 4 is a diagram for explaining an example of communication processing between platforms in the information processing system according to the present embodiment;

FIG. 5 is a diagram illustrating how one platform looks another platform in the information processing system according to the present embodiment;

FIG. 6 is a diagram illustrating how one platform looks another platform in the information processing system according to the present embodiment;

FIG. 7 is a diagram for explaining an example of a method for accessing a storage of another platform in the information processing system according to the present embodiment;

FIG. 8 is a block diagram illustrating an example of a characteristic configuration of a driver provided in a platform of the information processing system according to the present embodiment;

FIG. 9 is a sequence diagram illustrating an example of the flow of an initialization process of the driver in a platform according to the present embodiment;

FIG. 10 is a sequence diagram illustrating an example of the flow of a process of interrupting communication with another platform in the platform according to the present embodiment;

FIG. 11 is a sequence diagram illustrating an example of the flow of a process of resuming the communication with the other platform in the platform according to the present embodiment; and

FIG. 12 is a sequence diagram illustrating an example of the flow of a process of terminating communication in the platform according to the present embodiment.

### DETAILED DESCRIPTION

Hereinafter, an example of an information processing system and a platform according to an embodiment will be described with reference to the accompanying drawings.

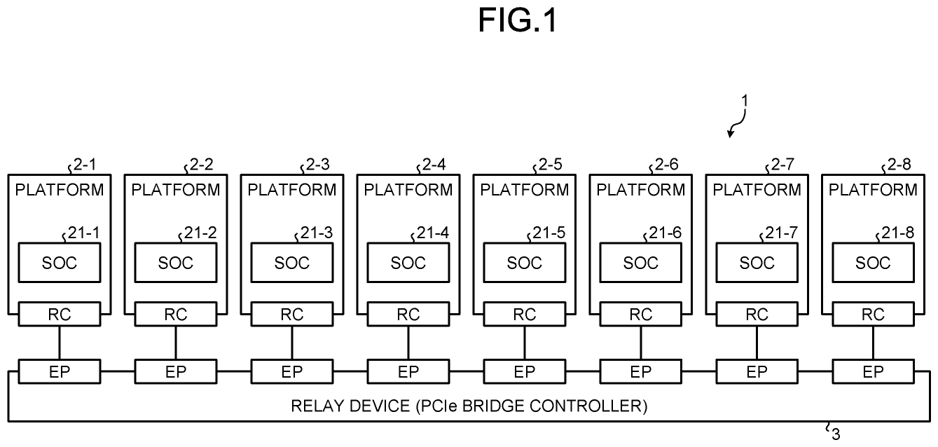

FIG. 1 is a diagram illustrating an example of an overall configuration of an information processing system according to the present embodiment. As illustrated in FIG. 1, an information processing system 1 according to the present embodiment includes a plurality of platforms 2-1 to 2-8 and a relay device 3. The platforms 2-1 to 2-8 are each connected to the relay device 3.

In the following description, when it is not necessary to distinguish the platforms 2-1 to 2-8 from one another and any desired platform is indicated, it is described as a platform 2. Furthermore, an example in which the information processing system 1 includes eight platforms 2-1 to 2-8 will be described below; however, the present invention is not limited thereto as long as the information processing system 1 includes a plurality of platforms 2.

The platforms 2-1 to 2-8 are a host PC (personal computer) serving as a control unit and a graphical user interface (GUI) of the information processing system 1, or an arithmetic unit that performs artificial intelligence (AI) inference processing, image processing, and the like.

Specifically, the platforms 2-1 to 2-8 include SOCs (system on a chip) 21-1 to 21-8, respectively. In the following description, when it is not necessary to distinguish the SOCs 21-1 to 21-8 from one another and any desired SOC is indicated, it is described as a SOC 21. The SOCs 21-1 to 21-8 may be provided by different manufacturers (vendors) or may be provided by the same manufacturer.

For example, it is assumed that the SOC 21-1 is provided by company A, the SOC 21-2 is provided by company B, the SOC 21-3 is provided by company C, the SOC 21-4 is provided by company D, the SOC 21-5 is provided by company E, the SOC 21-6 is provided by company F, the SOC 21-7 is provided by company G, and the SOC 21-8 is provided by company H.

Furthermore, different platforms 2 may be connected to each end point (EP) mounted on the relay device 3 or one platform 2 may be connected to each EP, and the platform 2 side may communicate with the relay device 3 by using a plurality of root complexes (RCs).

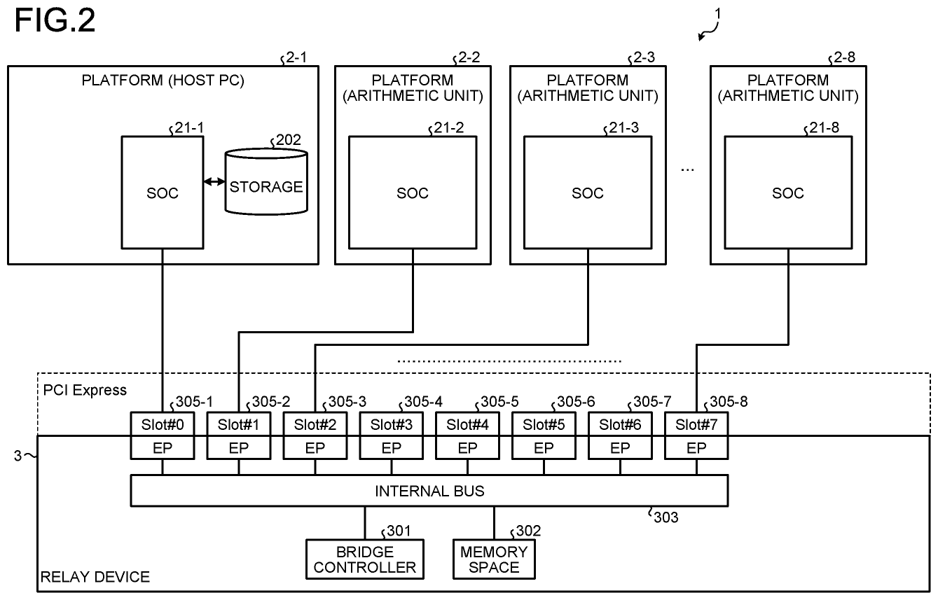

Next, with reference to FIG. 2, an example of a hardware configuration of the information processing system 1 according to the present embodiment will be described. FIG. 2 is a diagram illustrating an example of the hardware configuration of the information processing system according to the present embodiment. In the following description, an example in which the platform 2-1 serves as the host PC and the platforms 2-2 to 2-8 serve as the arithmetic units will be described.

First, the hardware configuration of the platform 2-1 serving as the host PC will be described.

As illustrated in FIG. 2, the platform 2-1 includes the SOC 21-1 and a storage 202.

The storage 202 is a storage device such as a hard disk drive (HDD), a solid state drive (SSD), and a storage class memory (SCM), and stores therein various types of data.

The SOC 21-1 is a chip on which a processor, a read-only memory (ROM), a random-access memory (RAM), and the like are mounted. The ROM stores therein various software programs and data for the software programs. The software programs stored in the ROM are read and executed by the processor. The RAM serves as a work area when the processor executes the software programs stored in the ROM.

The processor is a processor such as a central processing unit (CPU), a micro processing unit (MPU), a digital signal processor (DSP), an application specific integrated circuit (ASIC), a programmable logic device (PLD), and a field programmable gate array (FPGA), and controls the entire platform 2-1. The processor may be a multi-core processor or a combination of two or more processors.

Next, the hardware configuration of the platforms 2-2 to 2-8 serving as the arithmetic units will be described.

As illustrated in FIG. 2, the platform 2-2 includes the SOC 21-2. The SOC 21-2 is a chip on which a processor, a ROM, a RAM, and the like are mounted. The ROM stores therein various software programs and data for the software programs. The software programs stored in the ROM are read and executed by the processor. The RAM serves as a work area when the processor executes the software programs stored in the ROM.

The processor is a processor such as a CPU, an MPU, a DSP, an ASIC, a PLD, and an FPGA, and controls the entire platform 2-2. The processor may be a multi-core processor or a combination of two or more processors. For example, the processor may be a combination of a CPU and a GPU.

Hereinafter, the hardware configuration of the platform 2-2 will be described, but the other platforms 2-3 to 2-8 serving as the arithmetic units have the same hardware configuration as that of the platform 2-2.

Next, the hardware configuration of the relay device 3 will be described.

As illustrated in FIG. 2, the relay device 3 is, for example, a relay device having a plurality of EPs in one chip. As illustrated in FIG. 2, the relay device 3 includes a bridge controller 301, a memory space 302, an internal bus 303, and a plurality of slots 305-1 to 305-8. As illustrated in FIG. 2, the bridge controller 301, the memory space 302, and the slots 305-1 to 305-8 are communicably connected to one another via the internal bus 303 serving as an expansion bus such as PCIe.

Each of the slots 305-1 to 305-8 is a slot to which a device configured to satisfy the PCIe standard is connected. In the present embodiment, the platforms 2-1 to 2-8 are connected to the slots 305-1 to 305-8, respectively. In the following description, when it is not necessary to distinguish the slots 305-1 to 305-8 from one another and any desired slot is indicated, it is described as a slot 305. The platforms 2 are connected to the slot 305, so that the platforms 2 are connected to one another via the internal bus 303.

Furthermore, one platform 2 may be connected to one slot 305; however, by assigning a plurality of slots 305 to one platform 2, the platform 2 can perform communication using a wide communication band.

The memory space 302 is, for example, a memory including a ROM and a RAM. The ROM of the memory space 302 stores therein various software programs such as software programs related to communication control between the platforms 2 connected to the slot 305 and data for the software programs. The software programs stored in the ROM are read and executed by the bridge controller 301. The RAM of the memory space 302 serves as a work area when the software programs stored in the ROM of the memory space 302 are executed.

Furthermore, in relation to the platform 2, an address space is provided in the memory space 302 and the like in association with each slot 305. The relay device 3 performs data transfer between the platforms 2 based on an address provided for each slot 305.

The bridge controller 301 includes a processor such as a CPU, an MPU, a DSP, an ASIC, a PLD, and an FPGA, and the processor controls communication between the platforms 2 via the slots 305. The bridge controller 301 may include a combination of a plurality of processors. Furthermore, the bridge controller 301 implements communication between the platforms 2 connected to the slots 305 by executing the software programs stored in the memory space 302.

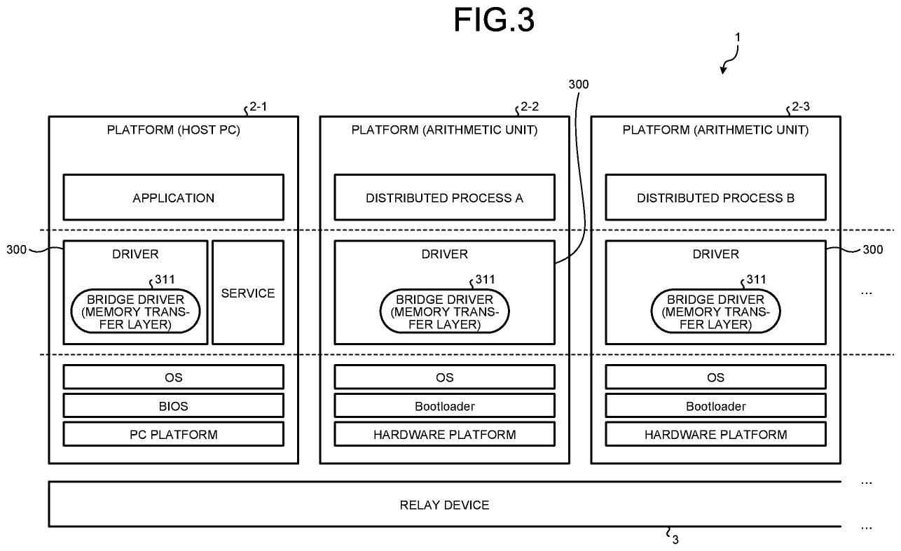

Next, with reference to FIG. 3, an example of a software configuration of the platform 2 of the information processing system 1 according to the present embodiment will be described. FIG. 3 is a diagram illustrating an example of the software configuration of the platform of the information processing system according to the present embodiment.

For example, the platform 2-1 uses Windows (registered trademark) as an operating system (OS) and executes various software programs on the OS. For example, the platforms 2-2 and 2-3 use Linux (registered trademark) as an OS and executes various software programs on the OS.

The platform 2 is provided with a driver 300 including a bridge driver 311 and communicates with the relay device 3 and another platform 2 via the driver 300. Each platform 2 has the SOC 21 as described above. The processor having the SOC 21 performs various functions of the platform 2 by executing the OS, various computer programs, the driver 300, and the like stored in the ROM of the SOC 21.

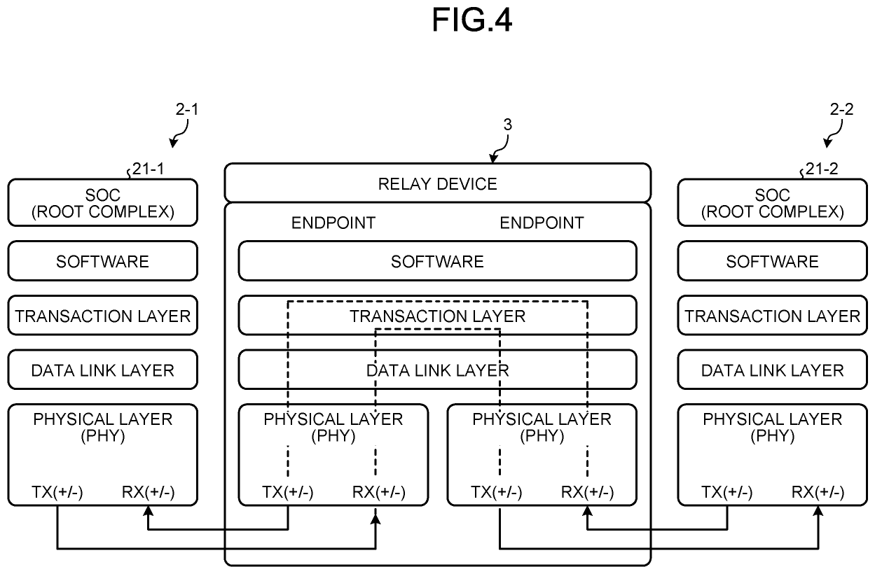

Next, with reference to FIG. 4, an example of communication processing between the platforms 2-1 and 2-2 connected to the relay device 3 will be described. FIG. 4 is a diagram for explaining an example of communication processing between the platforms in the information processing system according to the present embodiment. Hereinafter, an example of communication processing between the SOC 21-1 of the platform 2-1 and the SOC 21-2 of the platform 2-2 will be described; however, it is assumed that communication is performed between the SOCs 21 of the other platforms 2 in the same manner.

In the transmission source platform 2-1, data generated in the SOC 21-1 is sequentially transferred to software, a transaction layer, a data link layer, and a physical layer (PHY), and is transferred to a physical layer of the relay device 3 through the physical layer.

In the relay device 3, the data transferred from the transmission source platform 2-1 is sequentially transferred to the physical layer, a data link layer, and a transaction layer, and then is transferred to an EP corresponding to the transmission destination platform 2-2 through tunneling. That is, in the relay device 3, data is transferred from one SOC 21-1 to another SOC 21-2 by tunneling the data between EPs.

The data transferred to the transmission destination platform 2-2 from the relay device 3 is sequentially transferred to a physical layer (PHY), a data link layer, a transaction layer, and software, and then is transferred to the SOC 21-2 of the transmission destination platform 2-2. In the information processing system 1 of the present embodiment, communication between the platforms 2 is logically implemented when a PCIe transaction occurs.

When the transfer of data from the platforms 2 is not concentrated on a platform 2 connected to one of the slots 305 included in the relay device 3, it is also possible to perform data transfer in parallel between a plurality of different sets of any desired platforms 2.

For example, when the SOC 21-2 of the platform 2-2 and the SOC 21-3 of the platform 2-3 communicate with the SOC 21-1 of the platform 2-1, the relay device 3 serially processes the communication by the SOC 21-2 of the platform 2-2 and the SOC 21-3 of the platform 2-3.

On the other hand, when SOCs 21 of different platforms 2 communicate with each other and communication is not concentrated on a SOC 21 of a specific platform 2, the relay device 3 can also process the communication between the platforms 2 in parallel.

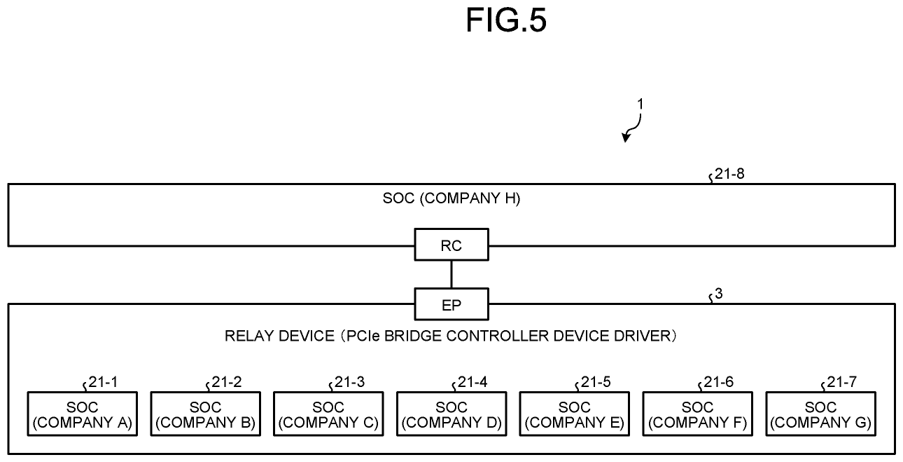

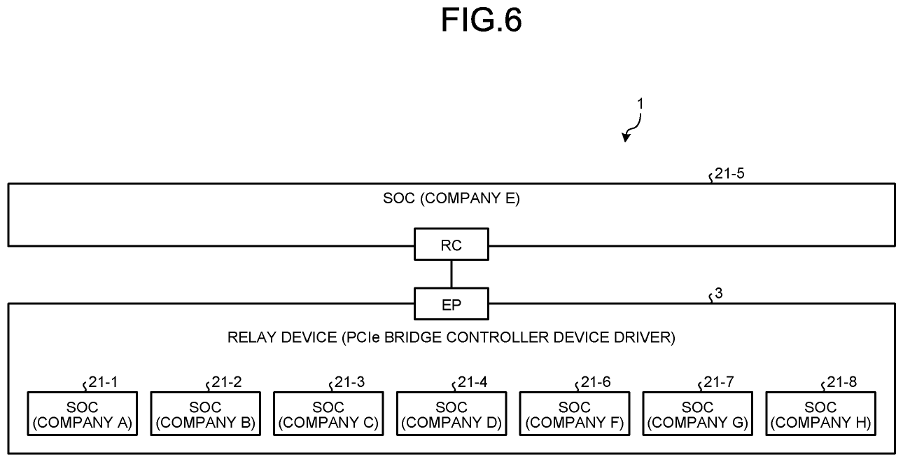

Next, with reference to FIG. 5 and FIG. 6, how the SOC 21 of a certain platform 2 looks the SOC 21 of another platform 2 will be described. FIG. 5 and FIG. 6 are diagrams illustrating how one platform looks another platform in the information processing system according to the present embodiment.

In a state in which communication is performed between the SOCs 21 of the respective platforms 2, since only the relay device 3 is visible from an OS (for example, a device manager of Windows (registered trademark)) executed by each of the SOCs 21, it is not necessary to directly manage the SOC 21 of another platform 2 to be connected. That is, a device driver of the relay device 3 manages the SOC 21 of the platform 2 connected to the end of the relay device 3.

Therefore, it is not necessary to prepare device drivers for operating the SOCs 21 of the platforms 2 which are a transmission source and a transmission destination and only the device driver of the relay device 3 performs communication processing with respect to the relay device 3, so that it is possible to implement communication between the platforms 2.

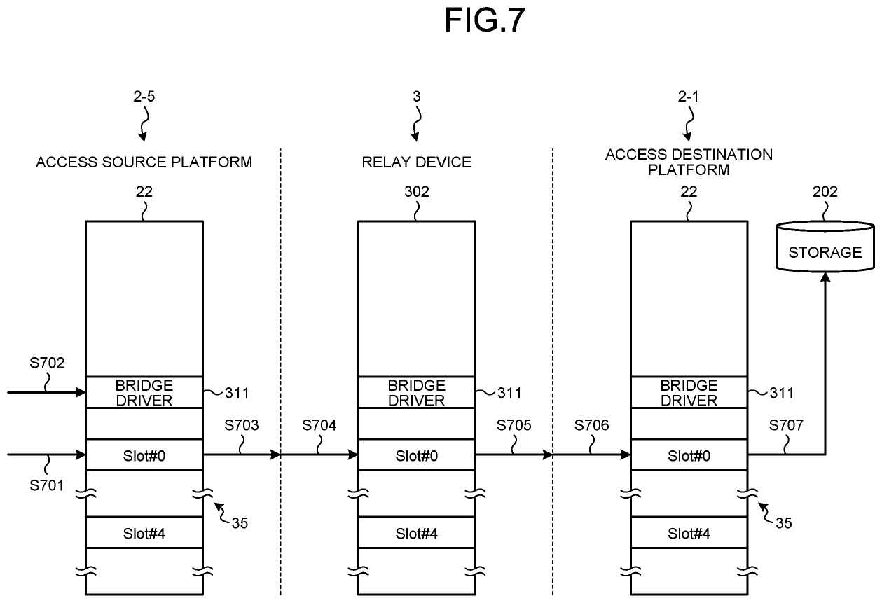

Next, with reference to FIG. 7, a method for accessing the storage 202 of another platform 2 from an access source platform 2 via the relay device 3 will be described. FIG. 7 is a diagram for explaining an example of a method for accessing a storage of another platform in the information processing system according to the present embodiment.

In the example illustrated in FIG. 7, a description will be given for a case where the platform 2-5 connected to Slot #4 accesses the storage 202 of the platform 2-1 connected to Slot #0.

The access source platform 2-5 issues an access request for the storage 202 of the access destination platform 2-1 with respect to an address range corresponding to the storage 202 of the access destination platform 2-1 in an address space 35 defined in the SOC 21-5 of the platform 2-5 (step S701). The address space 35 may be a part of a communication buffer where data to be transferred is temporarily stored. The address space 35 is an area provided in each of the platforms 2 with the same size as a physical memory 22 and the like provided in each of the platforms 2.

As illustrated in FIG. 7, the address space 35 includes address ranges Slot #0 to Slot #4 corresponding to the platforms 2. The address ranges Slot #0 to Slot #4 may be buffers where access requests to be transferred between the platforms 2 are temporarily stored. For example, the address range Slot #0 in the address space 35 is an address range corresponding to the platform 2-1 connected to the slot 305-1. Furthermore, the address range Slot #4 is an address range corresponding to the platform 2-5 connected to the slot 305-5.

Consequently, when the access request is transmitted to the platform 2-1 in step S701, the access source platform 2-5 writes the access request in the address range Slot #0 corresponding to the access destination platform 2-1 among the address ranges Slot #0 to Slot #4 in the address space 35.

Next, based on the address range Slot #0, the bridge driver 311 of the platform 2-5 acquires or generates slot information, which indicates the slot 305-1 to which the access destination platform 2-1 is connected, and address information of the address range Slot #0 in the address space 35 of the access destination platform 2-1 (step S702).

Next, the bridge driver 311 of the platform 2-5 hands over the acquired or generated slot information, address information, and the access request to the relay device 3 (step S703).

The relay device 3 has the address ranges Slot #0 to Slot #4 corresponding to each platform 2, similarly to the address space 35 of the platform 2. Consequently, in step S704, based on the slot information, the bridge controller 301 of the relay device 3 stores the slot information, the address information, and the access request in the address range Slot #0 corresponding to the platform 2-1 among the address ranges Slot #0 to Slot #4 of the memory space 302.

Next, the bridge controller 301 of the relay device 3 transmits the issued slot information, address information, and the access request to the access destination platform 2-1 (step S705). That is, the relay device 3 connects the access source slot 305 and the access destination slot 305 by EP-to-EP based on the slot information, and transmits the access request to the access destination platform 2-1.

Based on the slot information and the address information, the bridge driver 311 of the access destination platform 2-1 issues an access request to the address range Slot #0 corresponding to the platform 2-1 among the address ranges Slot #0 to Slot #4 of the address space 35 of the access destination platform 2-1 (step S706).

The issued access request is executed as access (write or read) to the storage 202 assigned to the address range Slot #0 (step S707).

By so doing, the storage 202 of the access destination platform 2-1 is accessed by the access source platform 2-5.

Meanwhile, when the access source platform 2 accesses the storage 202 of the access destination platform 2 by the access method illustrated in FIG. 7, the access source platform 2 first recognizes the access destination platform 2 as a platform on a virtual LAN. Next, the access source platform 2 generates an access request for the storage 202 provided in the access destination platform 2, and transmits the generated access request to the access destination platform via the relay device 3.

Furthermore, the access destination platform 2 also recognizes the access source platform as a platform on the virtual LAN. Next, the access destination platform 2 receives the access request from the access source platform 2 via the relay device 3, and accesses the storage 202 provided in the access destination platform 2 according to the access request.

However, when the access source platform 2 and the access destination platform 2 recognize each other as platforms 2 on the virtual LAN and transmit/receive an access request, processing and the like are required to convert the access request into an access request according to a communication standard of the virtual LAN, resulting in an increase in overhead in accessing the storage 202 provided in the access destination platform 2.

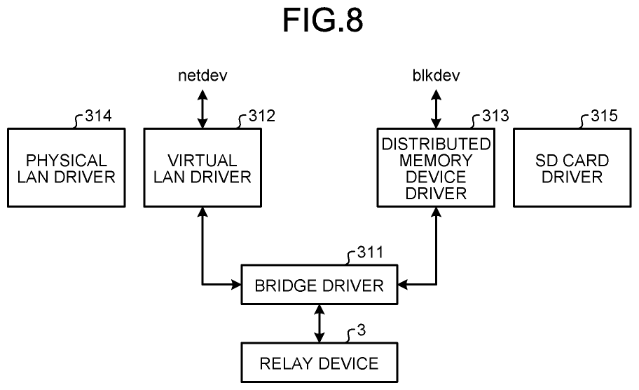

In this regard, in the present embodiment, in addition to a virtual LAN driver 312 (see FIG. 8) that recognizes the access destination platform 2 as a platform on the virtual LAN and generates an access request for the storage 202 provided in the access destination platform 2, a distributed memory device driver 313 (see FIG. 8) is provided in the access source platform 2. The distributed memory device driver 313 is an example of a block device driver that recognizes the storage 202 of the access destination platform 2 as a storage connected to the access source platform 2 and generates an access request for the storage 202.

In this way, when the access request for the storage 202 of the access destination platform 2 is transmitted from the access source platform 2, no processing and the like are required to convert the access request into an access request according to the communication standard of the virtual LAN. As a consequence, it is possible to reduce overhead in accessing the storage 202 provided in the access destination platform 2.

Next, with reference to FIG. 8, an example of a characteristic configuration of the driver 300 provided in the platform 2 according to the present embodiment will be described. FIG. 8 is a block diagram illustrating an example of the characteristic configuration of the driver provided in the platform of the information processing system according to the present embodiment.

In the present embodiment, as illustrated in FIG. 8, the driver 300 provided in the platform 2 includes various drivers such as the bridge driver 311, the virtual LAN driver 312, the distributed memory device driver 313, a physical LAN driver 314, and an SD card driver 315. The physical LAN driver 314 is a driver that enables communication with an external device via a LAN. The SD card driver 315 is a driver that recognizes an SD card connected to the platform 2 and executes access to the SD card.

Firstly, an example of the characteristic configuration of the driver 300 of the platform 2-5 serving as an example of the access source platform 2 will be described.

The bridge driver 311 is a driver that enables communication with the access destination platform 2-1 via the internal bus 303 provided in the relay device 3. Specifically, the bridge driver 311 reads an access request that is generated by the virtual LAN driver 312 or the distributed memory device driver 313 to be described later, from the address range Slot #0 corresponding to the access destination platform 2-1, and hands over the read access request to the relay device 3.

The virtual LAN driver 312 is a driver that recognizes the platform 2-1 as the platform 2 on the virtual LAN, generates an access request (hereinafter, referred to as a first access request: for example, a request to write or read various types of data to/from the storage 202) for the storage 202 of the platform 2-1, and transmits the first access request to the platform 2-1 via the bridge driver 311. Specifically, the virtual LAN driver 312 writes the generated first access request in the address range Slot #0 corresponding to the platform 2-1, thereby transmitting the first access request to the platform 2-1 via the bridge driver 311.

In the present embodiment, when an access request netdev is input via an application of the platform 2-5, another driver, and the like, the virtual LAN driver 312 converts the access request netdev into the first access request for requesting access to the storage 202 of the platform 2-1 with respect to the platform 2-1 recognized as existing on the virtual LAN. The access request netdev is an access request according to a network interface.

The distributed memory device driver 313 is an example of a block device driver that recognizes the storage 202 of the access destination platform 2-1 as a storage connected to the access source platform 2-5, generates an access request (hereinafter, referred to as a second access request) for the storage 202, and transmits the second access request to the platform 2-1 via the bridge driver 311. Specifically, the distributed memory device driver 313 writes the generated second access request in the address range Slot #0 corresponding to the platform 2-1, thereby transmitting the second access request to the platform 2-1 via the bridge driver 311.

In this way, when accessing the storage 202 of the access destination platform 2-1, no processing and the like are required to convert the access request for the storage 202 of the access destination platform 2-1 into an access request according to the communication standard of the virtual LAN. As a consequence, it is possible to reduce overhead in accessing the storage 202 provided in the access destination platform 2, in the access source platform 2-5.

In the present embodiment, when an access request blkdev is input from a file system included in the OS of the platform 2-5, the distributed memory device driver 313 recognizes the storage 202 of the access destination platform 2-1 as a device (storage) connected to the access source platform 2-5 itself, and converts the access request blkdev into the second access request for accessing the storage 202.

The access request blkdev is an access request for the storage 202 by the file system included in the OS of the platform 2. In the present embodiment, the access request blkdev is an access request in units of memory blocks included in the storage 202.

Furthermore, in the present embodiment, it is assumed that the storage 202 of the access destination platform 2-1 includes a distributed memory corresponding to each platform 2. In such a case, the distributed memory device driver 313 recognizes a distributed memory, which corresponds to the access source platform 2-5 itself among the distributed memories of the storage 202, as a storage connected to the access source platform 2-5, and generates a second access request.

In this way, when accessing the distributed memory corresponding to the access source platform 2-5, it is not necessary to convert an access request for the distributed memory of the access destination platform 2-1 into an access request according to the communication standard of the virtual LAN. As a consequence, it is possible to reduce overhead in accessing the distributed memory provided in the access destination platform 2-1, in the access source platform 2-5.

Furthermore, in the present embodiment, the storage 202 of the access destination platform 2-1 may include a ROM that is accessible by the platforms 2. In such a case, the ROM may store therein software programs for AI inference processing, image processing, and the like to be executed in the access source platform 2-5. Then, the distributed memory device driver 313 generates a second access request for requesting reading of the software programs stored in the ROM provided in the storage 202 of the access destination platform 2-1, and transmits the second access request to the access destination platform 2-1.

In this way, even though each platform 2 serving as the arithmetic unit does not store the software programs for AI inference processing, image processing, and the like, the software programs can be executed. As a consequence, in the platform 2 serving as the arithmetic unit, it is possible to reduce a storage capacity required for storing the software programs for AI inference processing, image processing, and the like.

Furthermore, in the present embodiment, when performing writing to the storage 202 of the access destination platform 2-1, the distributed memory device driver 313 generates a second access request for requesting reading of original data (hereinafter, referred to as original data) of a storage area to be written among the storage areas of the storage 202. Then, the distributed memory device driver 313 obtains difference information between the original data read from the storage 202 in response to the second access request and data written in the original data, and writes the difference information in the physical memory 22 of the access source platform 2-1. In such a case, since no writing is performed on the original data stored in the storage 202, a storage that stores therein the original data may be a ROM.

Thereafter, when data is written again in the storage 202 of the access destination platform 2-1, the distributed memory device driver 313 generates a second access request for requesting reading of original data of a storage area to be written among the storage areas of the storage 202. Then, based on the original data read from the storage 202 in response to the second access request and the difference information stored in the physical memory 22 of the access source platform 2-1, the distributed memory device driver 313 restores previously written data and performs writing on the restored data.

In this way, even though each platform 2 serving as the arithmetic unit does not store original data to be used for AI inference processing, image processing, and the like, writing can be performed on the original data. As a consequence, in the platform 2 serving as the arithmetic unit, it is possible to reduce a storage capacity required for storing the original data to be used for AI inference processing, image processing, and the like. Furthermore, since no writing is performed on the original data stored in the storage 202, the original data is read from the storage 202, so that it is possible to easily acquire the original data before the writing is performed.

Next, an example of the characteristic configuration of the driver 300 of the platform 2-1 serving as an example of the access destination platform 2 will be described.

The bridge driver 311 is a driver that enables communication with the access source platform 2-5 via the internal bus 303. Specifically, the bridge driver 311 writes an access request, the access request being received from the access source platform 2-5 via the relay device 3, in the address range Slot #0 corresponding to the access destination platform 2-1 itself. Thereafter, the bridge driver 311 hands over the access request stored in the address range Slot #0 to the virtual LAN driver 312 or the distributed memory device driver 313.

In the present embodiment, the bridge driver 311 determines whether the access request, the access request being received from the access source platform 2-5 via the internal bus 303 provided in the relay device 3, is an access request (that is, the first access request) transmitted after the access destination platform 2-1 is recognized as the platform 2 on the virtual LAN or an access request (that is, the second access request) transmitted after the access destination platform 2-1 is recognized the storage 202 of the access destination platform 2-1 as the storage connected to the access source platform 2-5.

Then, when it is determined that the received access request is the access request (that is, the first access request) transmitted after the access destination platform 2-1 is recognized as the platform 2 on the virtual LAN, the bridge driver 311 hands over (transmits) the received access request to the virtual LAN driver 312.

On the other hand, when it is determined that the received access request is the access request (that is, the second access request) transmitted after the storage 202 is recognized as the storage connected to the access source platform 2-5, the bridge driver 311 hands over (transmits) the received access request to the distributed memory device driver 313.

In this way, when it is determined that the received access request is the access request transmitted after the storage 202 is recognized as the storage connected to the access source platform 2-5, no processing is required to convert the received access request into an access request for the device driver of the storage 202. As a consequence, it is possible to reduce overhead in accessing the storage 202 provided in the access destination platform 2-1, in the access source platform 2-5.

The virtual LAN driver 312 recognizes the access source platform 2-5 as the platform 2 on the virtual LAN, and receives the access request for the storage 202, which has been determined as the first access request by the bridge driver 311. Next, the virtual LAN driver 312 converts the received first access request into the access request netdev according to the network interface. Then, the virtual LAN driver 312 controls access to the storage 202 by handing over the access request netdev to the application of the platform 2-1, another driver, and the like.

The distributed memory device driver 313 is an example of a block device driver that recognizes the storage 202 as the storage connected to the access source platform 2-5, receives the access request for the storage 202, which has been determined as the second access request by the bridge driver 311, and accesses the storage 202 based on the second access request.

In this way, when the access source platform 2-5 accesses the storage 202 provided in the access destination platform 2-1, it is not necessary to convert the access request received from the access source platform 2-5 into an access request for the device driver of the storage 202. As a consequence, it is possible to reduce overhead in accessing the storage 202 provided in the access destination platform 2-1, in the access source platform 2-5.

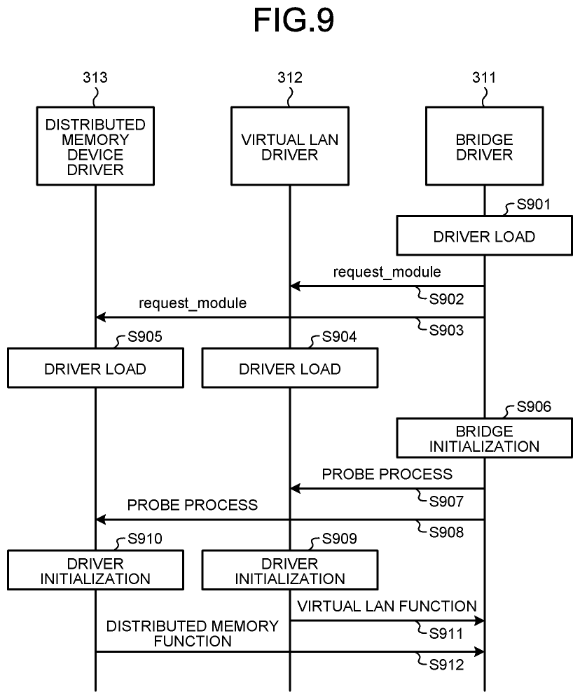

Next, with reference to FIG. 9, an example of the flow of an initialization process of the driver 300 in the platform 2 according to the present embodiment will be described. FIG. 9 is a sequence diagram illustrating an example of the flow of the initialization process of the driver in the platform according to the present embodiment.

First, the processor of the SOC 21 of each platform 2 executes a driver load for loading the bridge driver 311 that is stored in the ROM (step S901). Next, the bridge driver 311 generates a request_module that requests the loading of the virtual LAN driver 312 and the distributed memory device driver 313 (step S902 and step S903).

Next, when the request_module is generated, the processor of the SOC 21 of each platform 2 executes a driver load for loading the virtual LAN driver 312 and the distributed memory device driver 313 stored in the ROM (step S904 and step S905).

Next, the bridge driver 311 performs a bridge initialization process of initializing the bridge driver 311 itself (step S906). After the bridge initialization process, the bridge driver 311 performs a probe process of detecting another driver such as the virtual LAN driver 312 and the distributed memory device driver 313 (step S907 and step S908).

Furthermore, the virtual LAN driver 312 and the distributed memory device driver 313 also perform a driver initialization process of initializing the drivers 312 and 313 themselves (step S909 and step S910). Moreover, the virtual LAN driver 312 performs a virtual LAN function of recognizing another platform 2 as a platform on the virtual LAN via the bridge driver 311 (step S911). Furthermore, the distributed memory device driver 313 performs a distributed memory function of recognizing the storage 202 provided in the other platform 2 as a device connected to the platform 2 itself via the bridge driver 311 (step S912).

Thereafter, the virtual LAN driver 312 and the distributed memory device driver 313 perform the transmission/reception of the first and second access requests according to the aforementioned processing, thereby accessing the storage 202 provided in the access destination platform 2.

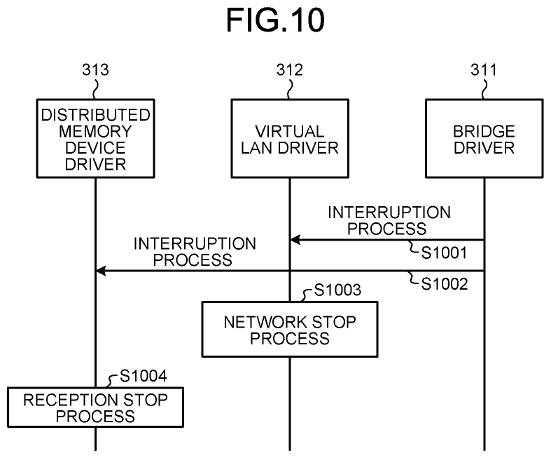

Next, with reference to FIG. 10, an example of the flow of a process of interrupting communication with another platform 2 in the platform 2 according to the present embodiment will be described. FIG. 10 is a sequence diagram illustrating an example of the flow of a process of interrupting communication with another platform in the platform according to the present embodiment.

When the interruption of communication between the platforms 2 is instructed by the relay device 3, the bridge driver 311 of each platform 2 performs an interruption process of instructing the virtual LAN driver 312 and the distributed memory device driver 313 to interrupt communication (step S1001 and step S1002).

When the interruption of communication between the platforms 2 is instructed by the bridge driver 311, the virtual LAN driver 312 performs a network stop process of interrupting the transmission/reception of the first access request (step S1003).

When the interruption of communication between the platforms 2 is instructed by the bridge driver 311, the distributed memory device driver 313 performs a reception stop process of stopping the reception of the input of the access request blkdev (step S1004).

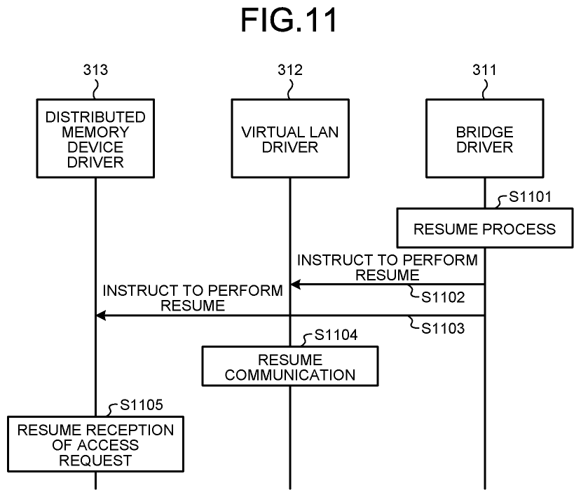

Next, with reference to FIG. 11, an example of the flow of a process of resuming the communication with the other platform 2 in the platform 2 according to the present embodiment will be described. FIG. 11 is a sequence diagram illustrating an example of the flow of a process of resuming the communication with the other platform in the platform according to the present embodiment.

When the execution of resume is instructed by the relay device 3 after the communication between the platforms 2 is interrupted by the process illustrated in FIG. 10, the bridge driver 311 of each platform 2 performs a process of resuming the communication between the platforms 2 (step S1101). Moreover, the bridge driver 311 instructs the virtual LAN driver 312 and the distributed memory device driver 313 to perform the resume (step S1102, step S1103).

When the execution of the resume is instructed by the bridge driver 311, the virtual LAN driver 312 performs the resume process of the virtual LAN function and resumes the communication with the other platform 2 (step S1104). Furthermore, when the execution of the resume is instructed by the bridge driver 311, the distributed memory device driver 313 performs the resume process of the distributed memory function, resumes the communication with the other platform 2, and resumes the reception of the input of the access request blkdev (step S1105).

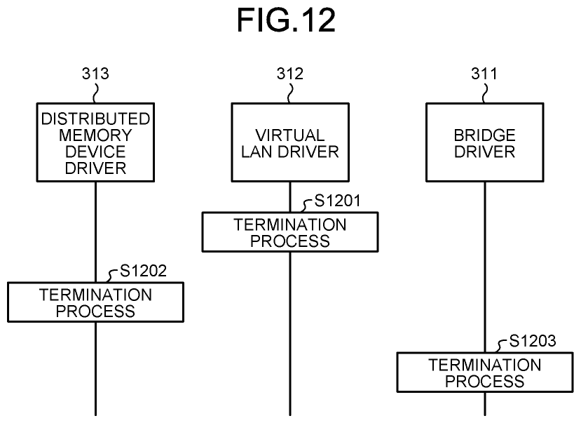

Next, with reference to FIG. 12, an example of the flow of a process of terminating communication in the platform 2 according to the present embodiment will be described. FIG. 12 is a sequence diagram illustrating an example of the flow of a process of terminating communication in the platform according to the present embodiment.

When the termination of the communication with the other platform 2 is instructed by a user of each platform 2, the processor of the SOC 21 of each platform 2 performs a termination process of terminating each driver in the order of the virtual LAN driver 312, the distributed memory device driver 313, and the bridge driver 311 (step S1201, step S1202, and step S1203).

As described above, in accordance with the information processing system 1 according to the present embodiment, when accessing the storage 202 of the access destination platform 2-1, no processing and the like are required to convert the access request for the storage 202 of the access destination platform 2-1 into an access request according to the communication standard of the virtual LAN. As a consequence, it is possible to reduce overhead in accessing the storage 202 provided in the access destination platform 2, in the access source platform 2-5.

Furthermore, in accordance with the information processing system 1 according to the present embodiment, when accessing a distributed memory corresponding to the access source platform 2-5, it is not necessary to convert an access request for the distributed memory of the access destination platform 2-1 into an access request according to the communication standard of the virtual LAN. As a consequence, it is possible to reduce overhead due to access to the distributed memory provided in the access destination platform 2-1, in the access source platform 2-5.

Furthermore, in accordance with the information processing system 1 according to the present embodiment, even though each platform 2 serving as the arithmetic unit does not store the software programs for AI inference processing, image processing, and the like, the software programs can be executed. As a consequence, in the platform 2 serving as the arithmetic unit, it is possible to reduce a storage capacity required for storing the software programs for AI inference processing, image processing, and the like.

In the aforementioned embodiment, the PCIe has been described an example of an I/O interface of each part; however, the I/O interface is not limited to the PCIe. For example, it is sufficient if the I/O interface of each part corresponds to a technology capable of performing data transfer between a device (peripheral controller) and a processor via a data transfer bus. The data transfer bus may be a general-purpose bus capable of transferring data at a high speed in a local environment (for example, one system or one device) provided in one housing and the like. The I/O interface may be any one of a parallel interface and a serial interface.

The I/O interface may be configured to perform a point-to-point connection and serially transfer data on a packet basis. Note that the I/O interface may have a plurality of lanes in the case of serial transfer. The layer structure of the I/O interface may have a transaction layer that generates and decodes a packet, a data link layer that performs error detection and the like, and a physical layer that performs serial-parallel conversion. Furthermore, the I/O interface may include a root complex, which has one or a plurality of ports at the top of the hierarchy, an end point being an I/O device, a switch for increasing ports, a bridge that converts a protocol, and the like. The I/O interface may transmit data to be transmitted and a clock signal by multiplexing them with a multiplexer. In such a case, a reception side may separate the data and the clock signal by a demultiplexer.

According to the first aspect of the present invention, it is possible to reduce overhead in accessing the storage included in the access destination platform from the access source platform.

According to the second aspect of the present invention, it is possible to reduce overhead due to access to the storage provided in the access destination platform, in the access source platform.

According to the third aspect of the present invention, it is possible to reduce overhead in accessing the storage provided in the access destination platform, in the access destination platform.

According to the fourth aspect of the present invention, it is possible to reduce overhead in accessing the storage provided in the access destination platform, in the access destination platform.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing system comprising:
a relay device that comprises an expansion bus; and
a plurality of platforms that are connected to each other via the expansion bus, wherein
one of the platforms serving as an access source platform comprises:
a first bridge driver that communicates with the platform serving as an access destination platform via the expansion bus;
a first virtual LAN driver that recognizes the access destination platform as a platform on a virtual LAN, generates a first access request for a storage in the access destination platform, and transmits the first access request to the access destination platform via the first bridge driver; and
a first block device driver that recognizes the storage as a storage connected to the access source platform, generates a second access request for the storage, and transmits the second access request to the access destination platform via the first bridge driver,
the access destination platform comprises:
a second bridge driver that communicates with the access source platform via the expansion bus and determines whether an access request for the storage that is received from the access source platform is the first access request or the second access request;
a second virtual LAN driver that recognizes the access source platform as the platform on the virtual LAN and receives the access request determined as the first access request by the second bridge driver; and
a second block device driver that recognizes the storage as the storage connected to the access source platform, receives the access request determined as the second access request by the second bridge driver, and accesses the storage based on the second access request.

2. The information processing system according to claim 1, wherein the storage includes a distributed memory corresponding to each of the platforms, and
the first block device driver is a distributed memory block driver that recognizes the distributed memory corresponding to the access source platform as the storage connected to the access source platform and generates the second access request for the distributed memory.

3. The information processing system according to claim 1, wherein the storage includes a ROM that is accessed by the platforms.

4. A platform comprising:
a bridge driver that communicates with an access destination platform via an expansion bus in a relay device;
a virtual LAN driver that recognizes the access destination platform as a platform on a virtual LAN, generates a first access request for a storage in the access destination platform, and transmits the first access request to the access destination platform via the bridge driver; and
a block device driver that recognizes the storage as a storage connected to the block device driver, generates a second access request for the storage, and transmits the second access request to the access destination platform via the bridge driver.

5. A platform comprising:
a storage;
a bridge driver that communicates with an access source platform via an expansion bus in a relay device and determines whether an access request for the storage that is received from the access source platform is a first access request transmitted after the access source platform is recognized as a platform on a virtual LAN or a second access request transmitted after the storage is recognized as a storage connected to the access source platform;
a virtual LAN driver that recognizes the access source platform as the platform on the virtual LAN and receives the access request determined as the first access request by the bridge driver; and
a block device driver that recognizes the storage as the storage connected to the access source platform, receives the access request determined as the second access request by the bridge driver, and accesses the storage based on the second access request.
